(19) United States
(12) Patent Application Publication
(10) Pub. No.: US 2009/0052200 A1
(43) Pub. Date: Feb. 26, 2009

(54) Single source visible and IR vehicle headlamp

(76) Inventors: Thomas Tessnow, Weare, NH (US); Michael Tucker, Henniker, NH (US)

Correspondence Address: OSRAM SYLVANIA INC, 100 ENDICOTT STREET, DANVERS, MA, 01923, US

(21) Appl. No.: 11/894,891

(22) Filed: Aug. 22, 2007

(51) Int. Cl. F21S 8/10

(52) U.S. Cl. 362/510

(57) ABSTRACT

A vehicle light (10) that can be used, for example, in a headlamp assembly (25) for a headlight projection system for use with forward illumination, comprises a reflector (12) and a light source (14) operatively mounted with the reflector (12). Preferably, the light source (14) is a filamented, tungsten halogen lamp capsule providing visible radiation and IR radiation and the reflector (12) is elliptical. The headlamp assembly (25) is mounted in a housing (27). A lens (16), such as an aspheric projector lens, directs the visible and IR radiation emanating from the light source (14) toward a field (18) to be illuminated and a shutter (20), which provides the cutoff for the low beam, has a position (22) between the light source (14) and the lens (16). The shutter (20) is transparent to the IR radiation and opaque to the visible radiation and is moveable into and out of the position (22) between the light source (14) and the lens (16), for example, by actuation of a solenoid (23).

### TECHNICAL FIELD

This invention relates to light sources and more particularly to vehicle light sources. Still more particularly, it relates to single light sources that provide visible and infra-red (IF) illumination.

### BACKGROUND ART

An increasing number of vehicles is now offered with night visions systems designed to enhance driver visibility in low light environments. Briefly, such night vision systems include an IR light source mounted on the automobile and a compatible IR detector or camera configured to detect IR light waves reflected from objects in front of the automobile. The emitted and reflected IR energy, while invisible to the unaided human eye, is detectable by an IR camera tuned to the frequency of the emitted IR energy. The IR camera can output a video signal to a display, such as a head-up display, to provide an enhanced view of the approaching environment to the driver. Older night vision systems operated with far-IR or mid-IR light sources, while newer active night vision systems operate with near-IR light sources. Near-IR light sources or illuminators include, for example, IR laser diodes, filtered incandescent light sources, or the like.

Near-IR illuminators have a beam pattern similar to that of a high beam automotive headlamp and, therefore, must be aligned to ensure proper operation of the night vision system. Such alignment can be time consuming and costly (requiring special alignment equipment) in traditional deployments where the IR illuminators are mounted to the vehicle bumpers, grill, or other locations at the front of the vehicle. Furthermore, bumper-mounted IR illuminators can introduce styling concerns, may be susceptible to damage caused by road debris, and, due to their relatively low mounting position, may not provide an optimized IR beam pattern for enhanced pedestrian detection distances.

These current systems employ separate IF sources that require particular orientation and alignment and, further, the added sources are expensive and, of course, provide yet another component subject to failure. Such light sources are shown in U.S. Pat. Nos. 6,877,879 and 7,217,020.

### DISCLOSURE OF INVENTION

It is, therefore, an object of the invention to obviate the disadvantages of the prior art.

It is another object of the invention to enhance vehicle lighting.

Yet another object of the invention is the enhancement of night-time driving.

These object are accomplished, in one aspect of the invention, by the provision a vehicle light comprising: a reflector; a light source operatively mounted with the reflector, the light source providing visible and IR radiation; a lens for directing the visible and IR radiation emanating from the light source toward a field to be illuminated; and a shutter having a position between the light source and the lens, the shutter being transparent to the IR radiation and opaque to the visible radiation. The IR radiation can be picked up by a receptor and transmitted to a display within the cockpit of the vehicle. The system requires no extra IR sources but, instead, utilizes the inherent IR present in the operating light source.

### BRIEF DESCRIPTION OF THE DRAWINGS

FIG. 1 is a diagrammatic view of an embodiment of the invention; and

FIG. 2 is a graph of IR spectrum utilized with an embodiment of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

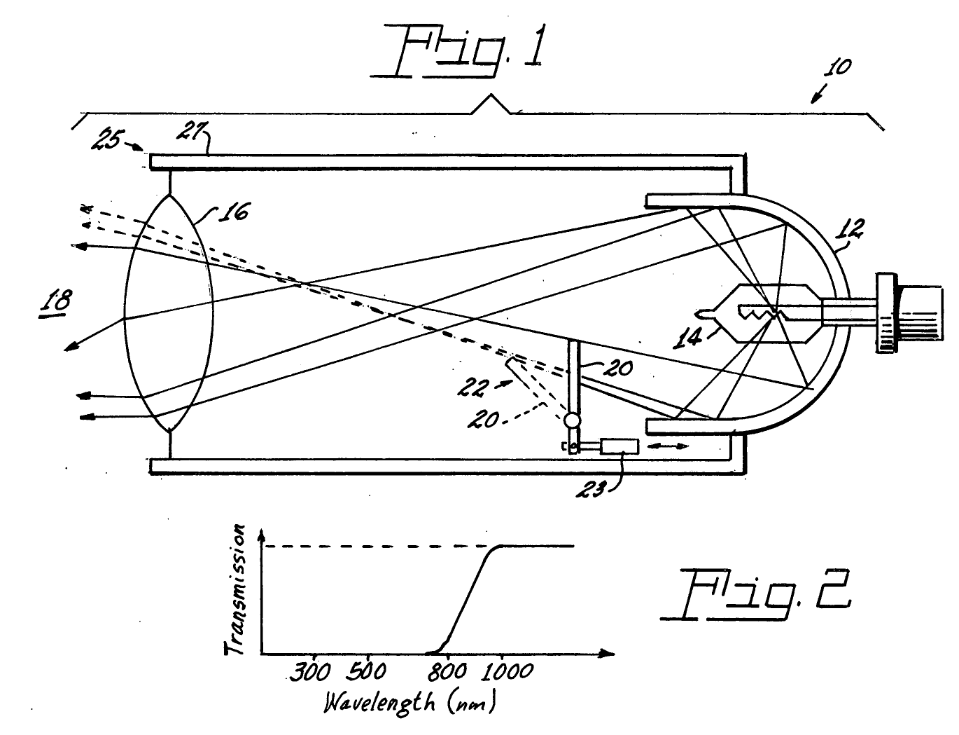

Referring now to the drawing with greater particularity, there is shown in FIG. 1 a vehicle light 10 that can be used, for example, in a headlamp assembly 25 for a headlight projection system for use with forward illumination, comprising a reflector 12 and a light source 14 operatively mounted with the reflector 12. Preferably, the light source 14 is a filamented, tungsten halogen lamp capsule providing visible radiation (shown as solid lines in FIG. 1) and IR radiation (shown as dotted lines in FIG. 1) and the reflector 12 is elliptical. The headlamp assembly 25 is mounted in a housing 27.

A lens 16, such as an aspheric projector lens, directs the visible and IR radiation emanating from the light source 14 toward a field 18 to be illuminated and a shutter 20, which provides the cutoff for the low beam, has a position 22 between the light source 14 and the lens 16. The shutter 20 is transparent to the IR radiation and opaque to the visible radiation (as shown graphically in FIG. 2) and is moveable into and out of the position 22 between the light source 14 and the lens 16, for example, by actuation of a solenoid 23.

In operation, the elliptical reflector 12 images the filament of the light source 14 and the projector lens 16 images the virtual image of the light source upon the field to be illuminated, such as roadway. When the shutter 20 is moved out of its position between the light source 14 and the lens 16, the light from the light source, both the visible and IR, is projected onto the roadway, that is, in what is considered to be the high beam mode. Actuating the shutter, that is, placing it in position between the light source 14 and the lens 16, cuts off the upper portion of the visible beam creating a sharp cutoff and the low beam mode. The IR radiation, however, is not cut off, but is continually transmitted through the shutter 20. This allows a receptor such as a camera mounted on the front of the vehicle, to image the roadway onto a screen in the vehicle cockpit, making it visible to the driver. Thus, the headlamp illuminates the roadway with IR radiation for the night vision system at a high beam level, at all times when the light source is operating, even if the shutter 20 is in low beam position and the visible beam is reduced to a low beam, which does not inconvenience oncoming drivers.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A vehicle light comprising:
a reflector;
a light source operatively mounted with said reflector, said light source providing visible and IR radiation;
a lens for directing the visible and IR radiation emanating from said light source toward a field to be illuminated; and
a shutter having a position between said light source and said lens, said shutter being transparent to said IR radiation and opaque to said visible radiation.

2. The vehicle light of claim 1 wherein said shutter is moveable into and out of said position between said light source and said lens.

3. The vehicle light of claim 2 wherein said light source is a filamented light source.

4. The vehicle light of claim 3 wherein said light source is a tungsten-halogen light source.

5. A headlamp assembly comprising:
a housing:
a reflector coupled to said housing;
a light source operatively mounted with said reflector, said light source providing visible and IR radiation;
a lens for directing the visible and IR radiation emanating from said light source toward a field to be illuminated; and
a shutter having a position between said light source and said lens, said shutter being transparent to said IR radiation and opaque to said visible radiation.

6. The headlamp assembly of claim 5 wherein said shutter is moveable into and out of said position between said light source and said lens.

7. The headlamp assembly of claim 6 wherein said lens closes said housing.

8. The headlamp assembly of claim 6 wherein a cover closes said housing.

9. The vehicle light of claim 1 wherein said reflector is elliptical/

10. The headlamp assembly of claim 5 wherein said reflector is elliptical.
